(19) United States
(12) Patent Application Publication
(10) Pub. No.: US 2026/0037825 A1
(43) Pub. Date: Feb. 5, 2026

(54) METHOD AND APPARATUS FOR FINE-TUNING LARGE LANGUAGE MODEL AND NON-TRANSITORY COMPUTER-READABLE MEDIUM

(71) Applicants: Yuming ZHANG, Beijing (CN); Bin DONG, Beijing (CN); Shanshan JIANG, Beijing (CN); Yongwei ZHANG, Beijing (CN); Hongyu LI, Beijing (CN)

(72) Inventors: Yuming ZHANG, Beijing (CN); Bin DONG, Beijing (CN); Shanshan JIANG, Beijing (CN); Yongwei ZHANG, Beijing (CN); Hongyu LI, Beijing (CN)

(73) Assignee: Ricoh Company, Ltd., Tokyo (JP)

(21) Appl. No.: 19/269,543

(22) Filed: Jul. 15, 2025

(30) Foreign Application Priority Data
Jul. 31, 2024 (CN) 202411049217.1

(51) Int. Cl. G06N 3/096; G06N 3/0475

(52) U.S. Cl. CPC G06N 3/096; G06N 3/0475

(57) ABSTRACT

A method of fine-tuning a large language model includes steps of obtaining training data containing first training data and second training data, the first training data being inclusive of a question, a plurality of candidate option numbers and their corresponding candidate option contents, and a correct option number and its corresponding correct option content, the correct option number and its corresponding correct option content being one of the plurality of the candidate option numbers and their corresponding candidate option contents, respectively, and the second training data being obtained by masking a candidate option content in the first training data; inputting the training data into the large language model to generate a predicted result by utilizing the large language model; and optimizing the large language model based on the predicted result as well as the correct option number and its corresponding correct option content.

### CROSS-REFERENCE TO RELATED APPLICATIONS

The present disclosure is based on and claims priority to Chinese Patent Application No. 202411049217.1 filed on Jul. 31, 2024, the entire contents of which are hereby incorporated by reference.

### BACKGROUND OF THE DISCLOSURE

### 1. Field of the Disclosure

The present disclosure relates to the technical field of machine learning and natural language processing, and specifically, a method and apparatus for fine-tuning a large language model as well as a non-transitory computer-readable medium.

### 2. Description of the Related Art

A large language model (LLM) is a type of deep learning technology based model, that usually includes a large number of parameters, and is used to process and generate a natural language text. The large language model is pre-trained by employing large-scale text data to learn the relationship, semantic information, and patterns between texts, thereby having powerful language understanding and generation capabilities.

The large language models are widely applied in the field of natural language processing (NLP), and may be particularly utilized for various tasks such as text generation, machine translation, sentiment analysis, question answering systems, and the like. By means of fine-tuning or transfer learning, the large language models can be adjusted in accordance with the demands of specific tasks or fields to adapt to different application scenarios. The emergence and development of these models have greatly promoted the progress of the natural language processing technology, and have attained remarkable achievements in various fields.

A multiclass classification task refers to a task conducting classification among multiple class labels, and the predicted class corresponds to one of the multiple class labels. The Large language models may be adopted to perform various multiclass classification tasks such as sentiment analysis, text classification, named entity recognition, and so on. In these tasks, the large language models receive input texts and output the corresponding classes or labels. By way of fine-tuning, it is possible to apply a pre-trained large language model to a specific multiclass classification task to improve the performance of the model on the task. At present, although most large language models have made great progress in ordinary conversations, they do not perform well enough in the multiclass classification tasks.

### SUMMARY OF THE DISCLOSURE

At least one embodiment of the present disclosure provides a method and apparatus for fine-tuning a large language model, that can, when the large language model is applied to a multiclass classification task, improve the performance of the large language model, and ameliorate the accuracy of the predicted result of the large language model. In other embodiments of the present disclosure, it is also possible to reduce the complexity of the predicted result of a decoding large language model in a downstream task and the time consumption for obtaining the predicted result of the decoding large language model.

According to a first aspect of the present disclosure, a method of fine-tuning a large language model is provided that includes steps of obtaining training data containing first training data and second training data, wherein, the first training data includes a question, a plurality of candidate option numbers and their corresponding candidate option contents, and a correct option number and its corresponding correct option content, the correct option number and its corresponding correct option content are one of the plurality of the candidate option numbers and their corresponding candidate option contents, respectively, and the second training data is obtained by masking a candidate option content in the first training data; inputting the training data into the large language model to generate a predicted result by utilizing the large language model; and optimizing the large language model based on the predicted result as well as the correct option number and its corresponding correct option content.

As an option, the step of optimizing the large language model based on the predicted result as well as the correct option number and its corresponding correct option content includes steps of calculating a first loss between a predicted option number in the predicted result and the correct option number; calculating, for the second training data in which the predicted option number is identical to the correct option number and the masked candidate option content is identical to the correct option content, a second loss between a predicted option content in the predicted result and the correct option content; and calculating a total loss based on the first loss and the second loss to optimize the large language model with a goal of minimizing the total loss.

As an option, the step of inputting the training data into the large language model to generate the predicted result by utilizing the large language model includes converting, by way of a tokenizer, each token in the training data into a corresponding identifier (ID) to acquire a first ID list composed of the corresponding ID of each token, and replacing each first-class ID in the first ID list with a predetermined ID to acquire a second ID list corresponding to the first ID list, wherein, the first-class IDs are the remaining IDs except the IDs corresponding to the correct option number and the correct option content, and the tokens corresponding to the predetermined ID are ignored in a process of optimizing the large language model; and inputting the first ID list into the large language model to generate the predicted result by utilizing the large language model, wherein, the i-th predicted value in the predicted result is a predicted result for the i+1-th ID in the first ID list, generated by the large language model based on a part of the IDs in the first ID list up to the i-th ID.

As an option, the first loss between the predicted option number and the correct option number is represented by a loss value between the ID corresponding to the predicted option number and the ID corresponding to the correct option number, and the second loss between the predicted option content and the correct option content is represented by a loss value between the ID corresponding to the predicted option content and the ID corresponding to the correct option content.

As an option, the method of fine-tuning the large language model of further includes steps determining a second position based on a first position of the ID corresponding to the correct option number in the second ID list, wherein, the second position is a previous position of the first position, obtaining a predicted value at the second position from the predicted result to obtain a probability value of each ID in the tokenizer, and selecting the ID with the maximum probability value to serve as the ID corresponding to the predicted option number; and determining a fourth position based on a third position of the ID corresponding to the correct option content in the second ID list, wherein, the fourth position contains a previous sub-position of each sub-position in the third position, obtaining a predicted value at the fourth position from the predicted result to obtain a probability value of each ID in the tokenizer, and selecting the ID with the maximum probability value to serve as the ID corresponding to the predicted option content.

As an option, the step of obtaining the training data includes steps of acquiring labeled original training data, wherein, the original training data contains at least a question, a plurality of candidate option contents, and a label, and the label is used to indicate the correct option content in the plurality of candidate option contents; constructing a prompt based on a prompt template and the original training data, and stitching contents in the prompt to acquire the first training data corresponding to the original training data; and replacing any one of the plurality of candidate option contents in the first training data with a mask to acquire the second training data corresponding to the original training data.

As an option, the method of fine-tuning the large language model further includes steps of receiving a text to be inferred, wherein, the text to be inferred contains a first question as well as a plurality of candidate option numbers and their corresponding option contents; inputting the text to be inferred into the optimized large language model, and setting the optimized large language model to generate only a predicted result of a correct option number; and determining the correct option number and/or the correct option content based on the predicted result of the correct option number generated by the optimized large language model.

As an option, the first question in the text to be inferred is received from a client, and the plurality of candidate option numbers in the text to be inferred are set based on setting information or setting update information received by a user interface (UI).

According to a second aspect of the present disclosure, an apparatus for fine-tuning a large language model is provided that includes a data obtainment part configured to obtain training data containing first training data and second training data, wherein, the first training data includes a question, a plurality of candidate option numbers and their corresponding candidate option contents, and a correct option number and its corresponding correct option content, the correct option number and its corresponding correct option content are one of the plurality of the candidate option numbers and their corresponding candidate option contents, respectively, and the second training data is obtained by masking a candidate option content in the first training data; and a model training part configured to input the training data into the large language model to generate a predicted result by utilizing the large language model, and optimize the large language model based on the predicted result as well as the correct option number and its corresponding correct option content.

As an option, the model training part is further configured to calculate a first loss between a predicted option number in the predicted result and the correct option number; calculate, for the second training data in which the predicted option number is identical to the correct option number and the masked candidate option content is identical to the correct option content, a second loss between a predicted option content in the predicted result and the correct option content; and calculate a total loss based on the first loss and the second loss to optimize the large language model with a goal of minimizing the total loss.

As an option, the model training part is further configured to convert, by way of a tokenizer, each token in the training data into a corresponding ID to acquire a first ID list composed of the corresponding ID of each token, and replace each first-class ID in the first ID list with a predetermined ID to acquire a second ID list corresponding to the first ID list, wherein, the first-class IDs are the remaining IDs except the IDs corresponding to the correct option number and the correct option content, and the tokens corresponding to the predetermined ID are ignored in a process of optimizing the large language model; and input the first ID list into the large language model to generate the predicted result by utilizing the large language model, wherein, the i-th predicted value in the predicted result is a predicted result for the i+1-th ID in the first ID list, generated by the large language model based on a part of the IDs in the first ID list up to the i-th ID.

As an option, the first loss between the predicted option number and the correct option number is represented by a loss value between the ID corresponding to the predicted option number and the ID corresponding to the correct option number, and the second loss between the predicted option content and the correct option content is represented by a loss value between the ID corresponding to the predicted option content and the ID corresponding to the correct option content.

According to a third aspect of the present disclosure, an apparatus for fine-tuning a large language model is provided that includes a processor and a storage coupled to the processor. The storage stores a computer-executable program that causes, when executed by processor, the processor to implement the method of fine-tuning the large language model in accordance with the first aspect of the present disclosure.

According to a fourth aspect of the present disclosure, a non-transitory computer-readable storage medium storing a computer-executable program for execution by a processor (in a computer, for example) is provided. The computer-executable program causes, when executed by the processor, the processor to implement the method of fine-tuning the large language model in accordance with the first aspect of the present disclosure.

According to a fifth aspect of the present disclosure, a computer-executable program including computer instructions is provided. The computer-executable program causes, when executed by a processor (in a computer, for example), the processor to implement the method of fine-tuning the large language model in accordance with the first aspect of the present disclosure.

Compared to the prior art, the method and apparatuses for fine-tuning a large language model, provided in the embodiments of the present disclosure can improve the performance of the large language model when applied to a multiclass classification task, ameliorate the accuracy of the predicted result of the large language model, and reduce the complexity of the predicted result of a decoding large language model in a downstream task and the time consumption for obtaining the predicted result of the decoding large language model.

### BRIEF DESCRIPTION OF THE DRAWINGS

FIG. 1 is a flowchart of a method of fine-tuning a large language model in accordance with an embodiment of the present disclosure;

FIG. 2 illustrates a structure of an apparatus for fine-tuning a large language model in accordance with an embodiment of the present disclosure;

FIG. 3 shows another structure of an apparatus for fine-tuning a large language model in accordance with an embodiment of the present disclosure;

FIG. 4 represents a structure of an automated question answering system in accordance with an embodiment of the present disclosure;

FIG. 5 is a block diagram of an exemplary hardware structure of a computer in accordance with an embodiment of the present disclosure;

FIG. 6 is a block diagram of an exemplary hardware structure of a mobile terminal in accordance with an embodiment of the present disclosure;

FIG. 7 is a block diagram of an automated question answering apparatus in accordance with an embodiment of the present disclosure;

FIG. 8 illustrates examples of a question answering system related information table, a prompt template, and an answer template adopted in the embodiments of the present disclosure, respectively;

FIG. 9 represents an example of addition of a candidate option used in the embodiments of the present disclosure;

FIG. 10 shows examples of an updated question answering system related information table and an updated prompt template utilized in the embodiments of the present disclosure, respectively; and

FIG. 11 illustrates an exemplary workflow of an automated question answering system in accordance with an embodiment of the present disclosure.

### DETAILED DESCRIPTION OF THE PREFERRED EMBODIMENTS

In order to let a person skilled in the art better understand the present disclosure, hereinafter, the embodiments of the present disclosure are concretely described with reference to the drawings. However, it should be noted that the same symbols, that are in the specification and the drawings, stand for the constituent elements having basically the same function and structure, and the repetition of the explanations to the constituent elements is omitted.

When a large language model is applied to a multiclass classification task, the related technology usually provides the corresponding data to fine-tune the large language model. In general, the fine-tuning process in the related technology allows the large language model to learn why an option is correct, but there does not exist a process of learning why an option is incorrect.

An embodiment of the present disclosure proposes a method of fine-tuning a large language model by masking an option content, so that the large language model can more fully learn the knowledge in training data, thereby improving the classification performance of the large language model.

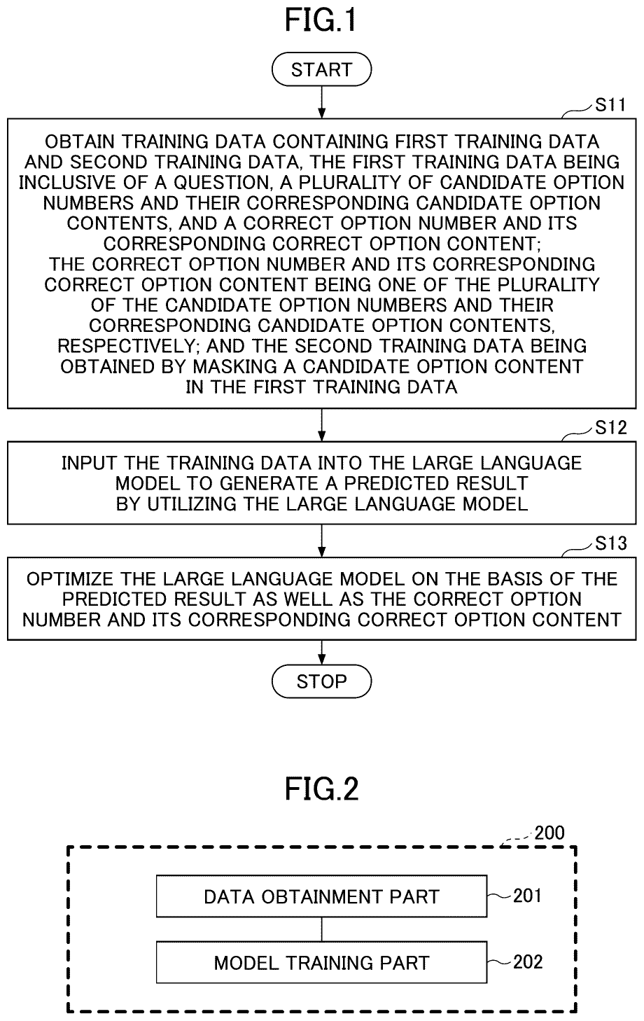

As shown in FIG. 1, the method of fine-tuning the large language model provided by this embodiment includes STEPS S11 to S12.

STEP S11 is obtaining training data containing first training data and second training data. The first training data is inclusive of a question, a plurality of candidate option numbers and their corresponding candidate option contents, and a correct option number and its corresponding correct option content. The correct option number and its corresponding correct option content are one of the plurality of the candidate option numbers and their corresponding candidate option contents, respectively, and the second training data is obtained by masking a candidate option content in the first training data.

In this embodiment, the first training data is obtained on the basis of a prompt template structure or obtained by directly letting original training data meeting a predetermined condition be the first training data. Specifically, the first training data needs to meet the following condition (i.e., the predetermined condition), namely, the first training data includes a question, a plurality of candidate option numbers and their corresponding candidate option contents, and a correct option number and its corresponding correct option content. Here, the correct option number and its corresponding correct option content are one of the plurality of candidate option numbers and their corresponding candidate option contents, respectively.

In what follows, an example of constructing the first training data by way of a prompt template is taken for illustration. The prompt template also needs to include a question, a plurality of candidate option numbers and their corresponding candidate option contents, and a correct option number and its corresponding correct option content. Here, the correct option number and its corresponding correct option content are one of the plurality of candidate option numbers and their corresponding candidate option contents, respectively.

In this embodiment, it is possible to acquire labeled original training data. The original training data contains at least a question, a plurality of candidate option contents, and a label. Here, the label is used to indicate the correct option content in the plurality of candidate option contents. Subsequently, a prompt (also called a prompt text) is constructed on the basis of the prompt template and the original training data, and then, the contents in the prompt are stitched, thereby acquiring the first training data corresponding to the original training data. Specifically, the candidate option numbers may be represented by letters such as A, B, C, and so on, numbers such as 1, 2, 3, and so forth, or other forms; there is not any limitation in the embodiments of the present disclosure. Moreover, in this step, it is also possible to replace any one of the plurality of candidate option contents in the first training data with a mask to acquire the second training data corresponding to the first training data.

Here, the mask adopts [MASK]. [MASK] is a special character in the tokenizer of the large language model, indicating that the corresponding content is masked. The masked data is regarded as new data (i.e., the second training data) obtained after the first training data is enhanced, so that the large language model can carry out learning by using the elimination approach; that is, in a case where one option is unknown, the correct option can be determined on the basis of the other options.

Table 1 provides an example of the original training data. Table 2 is an example of the prompt template. Table 3 illustrates a Table 2 based prompt template that is an example of the first training data constructed on the basis of the original training data shown in Table 2. Table 4 shows an example of the second training data acquired by enhancing the first training data represented in Table 3. The prompt template is inclusive of a prompt, for example, “Select the correct answer from the options according to the question.”. In each of Tables 1 to 4, item names are represented by angle brackets, and the others are specific item contents. Of course, this is only one way of distinguishing that can be adopted; that is, other ways of distinguishing can also be utilized.

When constructing the first training data by means of the prompt template, the item names in Table 2 are respectively replaced with the item contents of the same item names in Table 1, thereby obtaining the first training data. For example, the item name <Question> in Table 2 is replaced with the item content “Which is the highest mountain in the world?” of the same item name <Question> in Table 1, and the item names <Option A>, <Option B>, <Option C>, and <Correct Answer>are respectively replaced with the item contents of the same item names in Table 1, thereby obtaining the first training data in Table 3. Furthermore, it is possible to obtain the second training data shown in Table 4 by masking the option content of the option A in Table 3. In the example of Table 4, the masked candidate option is also the correct option. Of course, it is also possible to obtain other second training data by masking the option content of the option B or C in Table 3. It should be noted that, in the embodiments of the present disclosure, it is possible to randomly mask one of the plurality of option contents in the first training data, so as to obtain the second training data. Of course, it is also possible to mask, for a plurality of pieces of first training data, one candidate option content in each of the plurality of pieces of first training data, so as to obtain a plurality of pieces of second training data. There is not any limitation in the embodiments of the present disclosure.

TABLE 1
Original Training Data

| <Question> | Which is the highest mountain in the world? | | | | |
|---|---|---|---|---|---|
| <Option A> | Mt. | <Option B> | Mont | <Option C> | Himalayas |
| | Everest | | Blanc | | |
| <Correct | The first option. | | | | |
| Answer> | | | | | |

TABLE 2
Prompt Template

```
Select the correct answer from the options according to the question.
Question: <Question>
Options:
  A. <Option A>
  B. <Option B>
  C. <Option C>
Answer: <Correct Answer>
```

TABLE 3
First Training Data

```
Select the correct answer from the options according to the question.
Question: Which is the highest mountain in the world?
Options:
  A. Mt. Everest
  B. Mont Blanc
  C. Himalayas
Answer: A Mt. Everest
```

TABLE 4
Second Training Data

```
Select the correct answer from the options according to the question.
Question: Which is the highest mountain in the world?
Options:
  A. [MASK]
  B. Mont Blanc
  C. Himalayas
Answer: A Mt. Everest
```

Additionally, it should also be pointed out that converting the original training data into the first training data by means of the prompt template is just a specific way to acquire the first training data; that is, the prompt template is not a requirement of the technical solution of the embodiments of the present disclosure. If the format of the original training data meets the predetermined condition, then it is also possible to directly make the original training data be the first training data.

STEP S12 is inputting the training data into the large language model to generate a predicted result by utilizing the large language model.

Here, each token in the training data is converted into a corresponding ID by way of a tokenizer, so as to acquire a first ID list composed of the corresponding ID of each token. The tokenizer is a tokenizer of the large language model. Usually, a large language model involves a tokenizer or a similar functional module. Specifically, the tokenizer splits the training data into one or more tokens in accordance with the tokens, and then, converts each token into a corresponding ID, thereby acquiring a first ID list composed of the IDs corresponding to the tokens. The token is the basic unit in text data, that may be a word, a punctuation mark, a sub-word, a character, etc. Each token has a corresponding ID (also called an index) in the tokenizer, and the corresponding ID may be in the form of a number.

Subsequently, each first-class ID in the first ID list is replaced with a predetermined ID to acquire a second ID list corresponding to the first ID list. The first-class IDs are the remaining IDs except the IDs corresponding to the correct option number and the correct option content. Here, the IDs corresponding to the correct option number and the correct option content refers to the IDs to which the tokens in the correct option number and the correct option content correspond. In the second ID list, the IDs corresponding to the tokens in the correct option number and the correct option content remains unchanged; that is, the above replacement is not required. The tokens corresponding to the predetermined ID are ignored during the large language model optimization process. In some embodiments of the present disclosure, the predetermined ID adopts [−100].

Afterwards, the first ID list is input into the large language model to generate a predicted result by making advantage of the large language model. The i-th predicted value in the predicted result is the predicted result for the i+1-th ID in the first ID list, generated by the large language model on the basis of the partial IDs in the first ID list up to the i-th ID. The value range of i is from 1 to M; here, M is the number of IDs in the first ID list. For example, if it is assumed that the first ID list includes 100 IDs, then the predicted result generated by the large language model also includes 100 predicted values, and each predicted value includes the probability value of the ID corresponding to each token in the tokenizer. The i-th predicted value is a predicted value generated by the large language model on the basis of the partial IDs from the first ID to the i-th ID in the first ID list, that represents the probability of each ID at the i-th position in the predicted result. Hence, it is possible to acquire the ID at the i-th position in the predicted result on the basis of the ID with the highest probability in the i-th predicted value.

STEP S13 is optimizing the large language model on the basis of the predicted result as well as the correct option number and its corresponding correct option content.

Here, the large language model is fine-tuned on the basis of the predicted result obtained by the large language model, for example, the predicted option number and the predicted option content as well as the correct option number and the correct option content, so that the large language model is optimized.

Specifically, there are many optimization approaches of fine-tuning the large language model. Hereinafter, a few examples are taken for illustration.

### Approach 1

(1) The first loss between the predicted option number in the predicted result and the correct option number is calculated.

When calculating the first loss between the predicted option number in the predicted result and the correct option number, the first loss is represented by the loss value between the ID corresponding to the predicted option number and the ID corresponding to the correct option number. Specifically, it is possible to represent the loss value by adopting cross entropy loss. The ID corresponding to the predicted option number may be determined in the following manner, namely, determining a second position on the basis of the first position of the ID corresponding to the correct option number in the second ID list, the second position being the previous position of the first position (i.e., the position immediately before (immediately prior to) the first position); obtaining the predicted value at the second position from the predicted result to acquire the probability value of each ID in the tokenizer; and selecting the ID with the maximum probability value to serve as the ID corresponding to the predicted option number.

For example, in the above STEP S12, the training data is input into the tokenizer of the large language model to obtain IDs=[ID₁, ID₂, . . . , IDₙ]; here, IDs represents the ID list acquired by dividing the training data using the tokenizer of the large language model, and ID stands for the digital representation acquired after a token is divided by the tokenizer of the large language model. The calculation may be expressed as follows.

$$IDs = tokenizer ( prompt ) \qquad ( 1 )$$

In the equation (1), tokenizer means the tokenizer of the large language model, and prompt denotes the training data.

Afterwards, IDs are copied and named as Labels (i.e., the second ID list). The remaining IDs except the IDs belonging to the correct option number and the correct option content in Labels are expressed by −100, thereby obtaining constructed Labels. Table 5 shows an example of the constructed Labels. In Table 5, each column in IDs represents a sub-list in IDs, and each [−100] in Labels represents a sub-list composed of −100, whose length is equal to the length of the corresponding column in IDs. The calculation may be expressed as follows.

$$gold\_index = Labels . index ( gold\_index ) \qquad ( 2 )$$

$$Labels = [ - 10 \; 0 ] * gold\_ind ex + Labels [ gold\_index : ] \qquad ( 3 )$$

In the equation (2), gold_index denotes a temporary variable, that represents the position of the ID belonging to the correct option number in Labels; Labels. index (gold label) stands for finding the position of gold label from Labels; and gold_label represents the ID of the correct option.

Additionally, in the equation (3), [−100]*gold_index means that the partial IDs before the position of the ID of the correct option number in Labels are represented by −100, and Labels [gold_index:] means that only the IDs from the position of the correct option number to the end in Labels are retained. The overall equation (3) means that the partial IDs before the position of the ID of the correct option in Labels are represented by −100, and then, stitched with the remaining part in Labels.

TABLE 5

| | | | | | |
|---|---|---|---|---|---|
| IDs | IDs_{—} | IDs_{—} | IDs_{—} | IDs_{—} | IDs_{—} |
| | Question | Candidate | Candidate | Correct | Correct |
| | | Option | Option | Option | Option |
| | | Number | Content | Number | Content |
| Labels | [−100] | [−100] | [−100] | IDs_{—} | IDs_{—} |
| | | | | Correct | Correct |
| | | | | Option | Option |
| | | | | Number | Content |

Subsequently, the constructed IDs are input into the large language model, thereby obtaining Logits=(Logit₁, Logitᵢ, . . . , Logitₙ); here, the length of Logits is the same as the length of Labels. The k-th Logit in Logits represents the prediction made by the large language model for the ID at the k+1-th position after knowing k IDs. This prediction contains the probabilities of all the IDs in the large language model vocabulary. The specific calculation is as follows.

$$Logits = L L M ( I D s ) \qquad ( 4 )$$

In the equation (4), Logits represents the predicted result of the large language model with respect to Labels, whose length is the same as the length of Labels, and LLM denotes the large language model.

After that, the first loss is calculated, so that the large language model learns to adapt to the data format and determine the correct option. It is possible to obtain the label, namely Label option representing the correct option number in Labels, acquire the corresponding logit, namely Logit_option in Logits, and calculate the first loss on the basis of Label_option and Logit_option. The specific calculation is as follows.

$$gold\_index = Labels . index ( Label\_option ) \qquad ( 5 )$$

$$Logit\_option = Logits [ gold\_index - 1 ] \qquad ( 6 )$$

$$Loss 1 = CrossEntropyLoss ( Logit\_option , Label\_option ) \qquad ( 7 )$$

In the equation (5), gold_index denotes a temporary variable, that represents the position of the ID, to which the correct option number corresponds, in Labels; Labels. index (Label_option) stands for finding the position of Label option from Labels; and Label option means the ID corresponding to the correct option number.

In the equation (6), Logit_option denotes the predicted result of the large language model with respect to the ID corresponding to the correct option number; Logits [gold_index−1] stands for obtaining the ID representing the correct option number from Logits on the basis of gold index; and −1 represents required alignment in the decoding process of natural language processing, that is used to perform alignment on a prediction and a label.

Moreover, in the equation (7), Loss1 denotes a first loss function in the process of optimizing Logit_option, that is utilized to calculate the updated value in the optimization process; and CrossEntroyLoss represents cross entropy loss, that is a classic function adopted to calculate a loss in the field of natural language processing.

(2) The second loss between the predicted option content in the predicted result and the correct option content is calculated with respect to the second training data in which the predicted option number is the same as the correct option number, and the masked candidate option content is the same as the correct option content.

Here, by calculating the second loss, during the fine-tuning process, it is possible to let the large language model learn why the other candidate options are incorrect and generate the correct option content at the same time in a case where the correct option content is masked by [MASK]. The second loss between the predicted option content and the correct option content is represented by the loss value between the ID corresponding to the predicted option content and the ID corresponding to the correct option content. Specifically, it is possible to adopt cross entropy loss to represent the loss value. There may exist a plurality of IDs corresponding to the predicted option content, and there may also exist a plurality of IDs corresponding to the correct option content.

Furthermore, the ID corresponding to the predicted option content may be determined in the following manner, i.e., determining a fourth position on the basis of the third position of the ID corresponding to the correct option content in the second ID list, the fourth position being inclusive of a previous sub-position of each sub-position in the third position; obtaining the predicted value at the fourth position from the predicted result to acquire the probability value of each ID in the tokenizer; and selecting the ID with the maximum probability value to serve as the ID corresponding to the predicted option content.

As described above, there may exist a plurality of IDs corresponding to the correct option content. An example is provided in the following Table 6 in which it is assumed that a word is an ID. Here, it should be noted that in Table 6, Zhu Mu Lang Ma Feng, Bo Lang Feng, and Xi Ma La Ya Shan (Mandarin Pinyin) stand for Mt. Everest, Mont Blanc, and Himalayas, respectively.

```
TABLE 6
Prompt:
Select the correct answer from the options according to the question.
(12 IDs)
Question: Which is the highest mountain in the world? (11 IDs)
Options: (2 IDs)
  A. Zhu Mu Lang Ma Feng (7 IDs)
  B. Bo Lang Feng (5 IDs)
  C. Xi Ma La Ya Shan (7 IDs)
Answer: A Zhu Mu Lang Ma Feng (8 IDs)
First Position: A
Second Position: :
Third Position: [Zhu Mu Lang Ma Feng] (5 IDs)
Fourth Position: [A Zhu Mu Lang Ma] (5 IDs)
```

For example, with respect to Logit_option, if the option number it represents is the correct option number, and the correct option content in the corresponding training data is masked, then Label, namely Label content representing the correct option content in Labels is obtained, and the corresponding Logit, namely Logit_content in Logits is acquired. Then, the second loss is calculated on the basis of Label content and Logit_content. The calculation is as follows.

$$gold\_index = Labels . index ( Label\_content ) \qquad ( 8 )$$

$$Logit\_content = Logits [ gold\_index - 1 : ] \qquad ( 9 )$$

$$Loss 2 = CrossEntropyLoss ( Logit\_content , Label\_content ) \qquad ( 10 )$$

In the equation (8), gold_index is a temporary variable, that represents the position of the ID, to which the correct option content corresponds, in Labels; Labels.index (Label_option) stands for finding the position of Label option from Labels; and Label_option denotes the ID list (that usually is a list composed of a plurality of IDs) representing the correct option content.

In the equation (9), Logit_option denotes the predicted result of the large language model for the ID corresponding to the correct option content; Logits [gold_index-1:] stands of obtaining the ID list representing the correct option content from Logits on the basis of gold index; −1 represents required alignment in the decoding process of natural language processing, that is used to perform alignment on a prediction and a label; and:denotes all the IDs from the position of gold_index−1 to the end of Logits.

Additionally, in the equation (10), Loss2 represents a second loss function in the process of optimizing Logit_option, that is utilized to calculate the updated value in the optimization process, and CrossEntroyLoss denotes cross entropy loss, that is a classic function adopted to calculate a loss in the field of natural language processing.

(3) A total loss is calculated on the basis of the first loss and the second loss, and the large language model is optimized with the goal of minimizing the total loss.

Here, it is possible to calculate the weighted sum of the first loss and the second loss on the basis of a predetermined weight to obtain the total loss, and optimize the large language model with the goal of minimizing the total loss, until a predetermined training completion condition is satisfied. The predetermined training completion condition may be that the total loss has met the related convergence condition, the training process has been executed a predetermined number of times, etc.; there is not any limitation in the embodiments of the present disclosure.

By means of the above steps, it is possible to utilize the training data of a multiclass classification task to construct the relevant training data, and fine-tune the large language model on the basis of the option number related first loss and the option content related second loss. Because the second loss is calculated on the basis of the predicted result obtained using the relevant training data in which the correct option content is masked, in the fine-tuning process, it is possible to, in a case where the correct option content is masked, make the large language model learn why the other candidate options are incorrect and generate the correct option content at the same time. In this way, it is possible to improve the performance of the large language model when it is applied to the multiclass classification task, and ameliorate the accuracy of the predicted result of the large language model.

### Approach 2

(1) The loss between each of the predicted option number and the predicted option content in the predicted result and the corresponding one of the correct option number and the correct option content is calculated. For example, the loss between the predicted option number and the correct option number as well as the loss between the predicted option content and the correct option number are calculated, and then, the two losses are summed, thereby obtaining the total loss.

(2) The large language model is optimized with the goal of minimizing the total loss.

Similarly, in Approach 2, the loss between the predicted option number and the correct option number is represented by the loss value between the ID corresponding to the predicted option number and the ID corresponding to the correct option number. Specifically, it is possible to make use of cross entropy loss to represent the loss value. The ID corresponding to the predicted option number may be determined in the following manner, namely, determining a second position on the basis of the first position of the ID corresponding to the correct option number in the second ID list, the second position being the previous position of the first position; obtaining the predicted value at the second position from the predicted result to acquire the probability value of each ID in the tokenizer; and selecting the ID with the maximum probability value to be the ID corresponding to the predicted option number.

Moreover, the loss between the predicted option content and the correct option content is represented by the loss value between the ID corresponding to the predicted option content and the ID corresponding to the correct option content. Specifically, it is possible to take advantage of cross entropy loss to represent the loss value. There may exist a plurality of IDs corresponding to the predicted option content, and there may also exist a plurality of IDs corresponding to the correct option content. The ID corresponding to the predicted option content may be determined in the following manner, i.e., determining a fourth position on the basis of the third position of the ID corresponding to the correct option content in the second ID list, the fourth position being inclusive of a previous sub-position of each sub-position in the third position; obtaining the predicted value at the fourth position from the predicted result to acquire the probability value of each ID in the tokenizer; and selecting the ID with the maximum probability value to serve as the ID corresponding to the predicted option content.

Furthermore, it is worth pointing out that in some specific tasks, the content masked by [MASK] may be the only answer; for instance, in the example shown in Table 3 above, Mt. Everest must be masked by [MASK]. However, in some other tasks, the content masked by [MASK] may not be the only answer. An example is given in the following Table 7.

TABLE 7

```
Question: Which of the following is a fruit?
Options:
  A. [MASK]
  B. Red
  C. Rabbit
Correct Answer: Apple
```

In this example, it is obvious that if the large language model thinks that the content of [MASK] is banana, it should also be correct. In this case, an expert model needs to be introduced to determine whether the content generated by the large language model is reasonable.

After Step 13 is conducted, it is possible to obtain an optimized large language model, and then, perform reasoning (also called inference) on a multiclass classification task by employing the optimized large language model. In the reasoning process, it is possible to receive a text to be reasoned, including a first question as well as a plurality of candidate option numbers and their corresponding option contents. Then, the text to be reasoned is input into the optimized large language model, so that a correct option number and a correct option content predicted by the optimized large language model is generated and output.

In order to decrease the decoding time and the decoding complexity of the output result of a large language model in the downstream task, it is possible to set the large language model to generate only the predicted result of the correct option number on the basis of the text to be reasoned, for example, generate only the token of the correct option number. In this way, the correct option number and/or the correct option content can be determined on the basis of the predicted result of the correct option number generated by the large language model. The predicted result of the correct option number generated by the large language model contains the probabilities of all the IDs in the large language model vocabulary. At this time, it is possible to extract only the probability of each candidate option number from the predicted result, and then, select the candidate option number with the maximum probability to be the correct option number. In addition, if only the correct option number is predicted by the large language model, then it is also possible to obtain the predicted correct option content on the basis of the option content corresponding to the predicted correct option number.

Concretely, it is possible to set the large language model to generate only one token to avoid the large language model from generating some other contents. The setting is as follow.

$$Logit\_option = {LLM}^{*} . generate ( IDs\_inference , max\_new \_tokens = 1 ) \qquad ( 11 )$$

In the equation (11), Logit_option represents the prediction of the large language model with respect to the correct option (this prediction contains the probability that each ID in the large language model vocabulary may appear); LLM* denotes the fine-tuned large language model; LLM*. generate (IDs inference, max new tokens=1) means that only one token is generated under the premise that IDs inference is known; and IDs inference stands for an ID list consisting of the IDs corresponding to the tokens in the question, the candidate option numbers, and the candidate option contents in the data to be reasoned.

Subsequently, for Logit_option, only the probabilities of the IDs of all the options are obtained, thereby reducing the difficulty of parsing the content generated by the large language model, and the largest probability is selected as the option generated by the large language model. The calculation is as follows.

$${Logit\_option}^{*} = [ Logit\_option [ I {D}_{A} ] , Logit\_option [ I {D}_{B} ] , Logit\_option [ {ID}_{C} ] ] \qquad ( 12 )$$

$$output = arg max ( {Logit\_option}^{*} ) \qquad ( 13 )$$

In the equation (12), Logit_option* means that only the probabilities of the IDs of the options A, B, and C are included; ID_{A}, ID_{B}, and ID_{C} represent the IDs of the options A, B, and C, respectively; and the overall equation (12) means that only the probability belonging to each option (in this example, the three options A, B, and C; it is also possible to increase an option(s) in accordance with the downstream task) in the predicted result are retained, and all the other probabilities are excluded.

Moreover, in the equation (13), output represents the final selection made by the relating system from the three options A, B, and C, and argmax(Logtis_option*) stands for selecting the largest ID (i.e., the ID having the largest probability) from Logtis_option* to be the ID corresponding to the correct option number.

Here, it should be noted that in the above method, it is possible to set the representation form of the candidate option numbers; for example, the candidate option numbers may be set to be represented by Arabic numerals, English letters, etc. Furthermore, it is also possible to set the number of candidate options; for example, the candidate options may be increased or decreased as needed. Specifically, a user interface (UI) may be provided. A user (e.g., an administrator) may input setting information or setting update information through the UI, so that the representation form and/or the number of the candidate option numbers may be set on the basis of the setting information or the setting update information received by the UI.

Of course, in the embodiments of the present disclosure, it is also possible to set the contents included in the predicted result generated by the large language model through the UI; for example, the contents may include the predicted correct option number, the predicted correct option content, or both the predicted correct option number and the predicted correct option content.

In what follows, an apparatus for implementing the above method is provided on the basis of the above method, according to an embodiment of the present disclosure. Referring to FIG. 2; an apparatus 200 for fine-tuning a large language model provided in this embodiment is inclusive of a data obtainment part 201 and a model training part 202.

The data obtainment part 201 is configured to obtain training data containing first training data and second training data. The first training data includes a question, a plurality of candidate option numbers and their corresponding candidate option contents, and a correct option number and its corresponding correct option content. The correct option number and its corresponding correct option content are one of the plurality of the candidate option numbers and their corresponding candidate option contents, respectively. The second training data is obtained by masking a candidate option content in the first training data.

In addition, the model training part 202 is configured to input the training data into the large language model to generate a predicted result by utilizing the large language model, and optimize the large language model on the basis of the predicted result as well as the correct option number and its corresponding correct option content.

By way of the data obtainment part 201 and the model training part 202, it is possible to improve the performance of the large language model when it is applied to a multiclass classification task, and ameliorate the accuracy of the predicted result of the large language model.

As an option, the model training part 202 is further configured to calculate the first loss between the predicted option number in the predicted result and the correct option number; calculate, for the second training data in which the predicted option number is identical to the correct option number and the masked candidate option content is identical to the correct option content, the second loss between the predicted option content in the predicted result and the correct option content; and calculate a total loss on the basis of the first loss and the second loss to optimize the large language model with the goal of minimizing the total loss.

As an option, the model training part 202 is further configured to convert, by way of a tokenizer, each token in the training data into a corresponding ID to acquire a first ID list composed of the corresponding ID of each token, and replace each first-class ID in the first ID list with a predetermined ID to acquire a second ID list corresponding to the first ID list. The first-class IDs are the remaining IDs except the IDs corresponding to the correct option number and the correct option content. The tokens corresponding to the predetermined ID are ignored in the process of optimizing the large language model. Then, the first ID list is input into the large language model to generate the predicted result by utilizing the large language model. The i-th predicted value in the predicted result is a predicted result for the i+1-th ID in the first ID list, generated by the large language model on the basis of the partial IDs in the first ID list up to the i-th ID.

As an option, the first loss between the predicted option number and the correct option number is represented by the loss value between the ID corresponding to the predicted option number and the ID corresponding to the correct option number. The second loss between the predicted option content and the correct option content is represented by the loss value between the ID corresponding to the predicted option content and the ID corresponding to the correct option content.

As an option, the apparatus 200 further includes a first determination part and a second determination part. The first determination part is configured to determine a second position on the basis of the first position of the ID corresponding to the correct option number in the second ID list, the second position being the previous position of the first position; obtain the predicted value at the second position from the predicted result to obtain the probability value of each ID in the tokenizer; and select the ID with the maximum probability value to serve as the ID corresponding to the predicted option number. The second determination part is configured to determine a fourth position on the basis of the third position of the ID corresponding to the correct option content in the second ID list, the fourth position being inclusive of the previous sub-position of each sub-position in the third position; obtain the predicted value at the fourth position from the predicted result to obtain the probability value of each ID in the tokenizer; and select the ID with the maximum probability value to serve as the ID corresponding to the predicted option content.

As an option, the data obtainment part 201 is further configured to obtain labeled original training data, the original training data being inclusive of at least a question, a plurality of candidate option contents, and a label, the label being used to indicate the correct option content in the plurality of candidate option contents; construct a prompt on the basis of a prompt template and the original training data; stitch the contents in the prompt to acquire the first training data corresponding to the original training data; and replace any one of the plurality of candidate option contents in the first training data with a mask to acquire the second training data corresponding to the original training data.

As an option, the apparatus 200 further includes an inferring part that is configured to receive a text to be inferred containing a first question as well as a plurality of candidate option numbers and their corresponding option contents; input the text to be inferred into the optimized large language model, and set the optimized large language model to generate only a predicted result of a correct option number; and determine the correct option number and/or the correct option content on the basis of the predicted result of the correct option number, generated by the optimized large language model.

As an option, the first question in the text to be inferred is received from a client. The plurality of candidate option numbers in the text to be inferred are set on the basis of the setting information or the setting update information received by a UI.

Here, it should be noted that the apparatus 200 in this embodiment is an apparatus corresponding the method in the embodiment above. As such, all the implementations in the above embodiment can be applied to the apparatus 200 in this embodiment, and can achieve the same technical effects. By means of the apparatus 200 in this embodiment, it is possible to fulfill all the steps of the method in the embodiment above, and attain the same technical effects. For the sake of convenience, the contents and the technical effects that are the same as those in the method of the above embodiment are omitted in this embodiment.

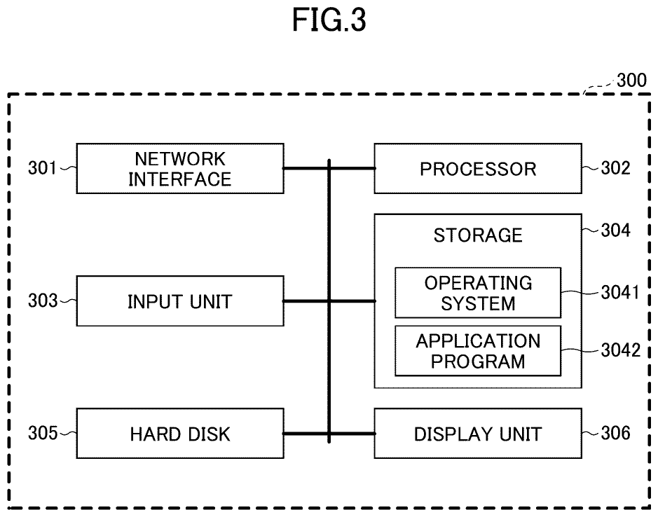

Hereinafter, another apparatus for fine-tuning a large language model is further provided in accordance with an embodiment of the present disclosure. Referring to FIG. 3; an apparatus 300 for fine-tuning a large language model in this embodiment includes a processor 302 and a storage 304 coupled to the processor 302. The storage 304 stores computer-executable program instructions (i.e., a computer-executable program or a computer program).

When the computer program stored in the storage 304 is executed by the processor 302, the computer program may cause the processor 302 to conduct the method in the embodiment above.

Moreover, as shown in FIG. 3, the apparatus 300 further includes a network interface 301, an input unit 303, a hard disk 305, and a display unit 306.

The network interface 301 may be configured to connect to a network such as the Internet, a local area network (LAN), or the like. The input unit 303 may be configured to let a user input various instructions, that may be a keyboard or a touch panel, for example. The hard disk 305 may be configured to store any information or data necessary to achieve the method in the above embodiment. The display unit 306 may be configured to display the result acquired when executing the computer program by the processor 302.

Furthermore, in an example, as shown in FIG. 3, the storage 304 may contain an operating system 3041 and an application program 3042. The computer program may be included in the application program 3042.

Here, it should be pointed out that the apparatus 300 in this embodiment is an apparatus corresponding the method in the embodiment above. As such, all the implementations of the method in the above embodiment can be applied to the apparatus 300 in this embodiment, and can achieve the same technical effects. By means of the apparatus 300 in this embodiment, it is possible to fulfill all the steps of the method in the embodiment above, and attain the same technical effects. For the sake of convenience, the contents and the technical effects that are the same as those in the method of the above embodiment are omitted in this embodiment.

In what follows, a computer program and a non-transitory computer-readable medium are provided in accordance with two embodiments of the present disclosure, respectively. The computer program may cause a computer including a processor to perform the method in accordance with the above embodiment. The non-transitory computer-readable medium may store computer-executable instructions (i.e., the computer program) for execution by a computer involving a processor. The computer-executable instructions may cause, when executed by the processor, the processor to execute the method in accordance with the above embodiment.

Here, it is noteworthy that when the computer-executable instructions are executed by the computer, it is possible to fulfill all the steps of the method in the embodiment above, and attain the same technical effects. For the sake of convenience, the contents and the technical effects that are the same as those in the method in accordance with the above embodiment are omitted in this embodiment.

On the basis of the above method or apparatuses for fine-tuning a large language model, it is possible to train a large language model, and then, implement an automated question answering system by employing the large language model. The following are details.

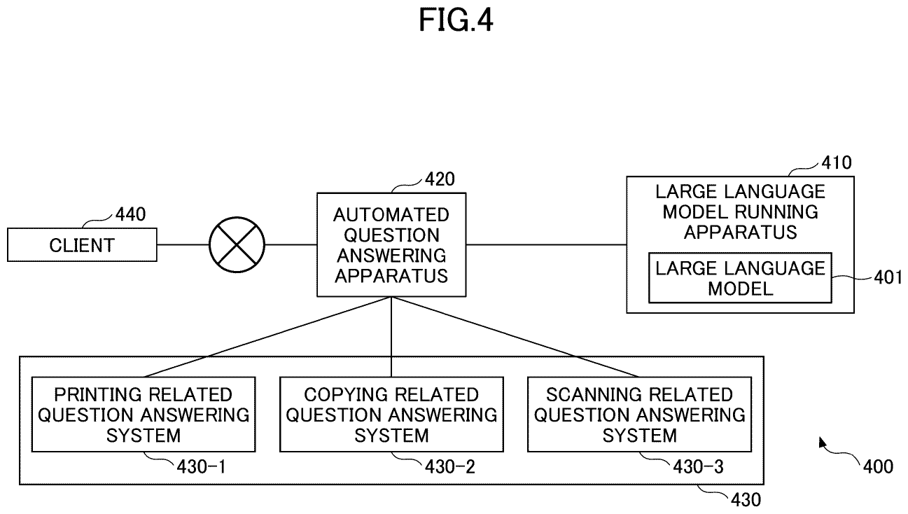

FIG. 4 is a structural diagram of an automated question answering system 400 in accordance with an embodiment of the present disclosure, that is inclusive of a large language model running apparatus 410, an automated question answering apparatus 420, a question answering system 430, and a client 440.

The large language model running apparatus 410 may be a server system consisting of one or more computers. An large language model 401 is run on the large language model running apparatus 410, and may be generated by the above method or apparatuses for fine-tuning a large language model.

The automated question answering apparatus 420 is usually a sever, and may be composed of one or more computers.

The question answering system 430 may specifically include one or more of a printing related question answering system 430-1, a copying related question answering system 430-2, and a scanning related question answering system 430-3, and each of these three question answering systems may be composed of one or more computers.

The client 440 may be a personal computer, a mobile terminal, or an application program running on the personal computer or the mobile terminal. The mobile terminal is a terminal apparatus operated by a user, and may be a smart phone, a personal digital assistant (PDA), a handheld apparatus with a wireless communication function, etc.

In the automated question answering system 400, the client 440 may be connected to the automated question answering apparatus 420 via a wired and/or wireless network, and send a question to the automated question answering apparatus 420 to request an answer to the question. The automated question answering apparatus 420 is connected to the large language model running apparatus 410 and the question answering system 430, respectively, and the connection may be a wireless and/or wired connection.

The functions of the large language model running apparatus 410, the automated question answering apparatus 420, and the client 440 may be distributed to a plurality of computers.

Concretely, the first question in the text to be reasoned is received from a client. The plurality of candidate option numbers in the text to be reasoned are set on the basis of the setting information or the setting update information received by a UI. For example, it is possible to set the representation form (e.g., using numbers 1, 2, 3, . . . or letters A, B, C, . . . ) and/or the number of the plurality of candidate option numbers in accordance with the setting information or the setting update information received by the UI.

The related hardware and software structures are introduced below.

### Hardware Structure

### (1) Computer

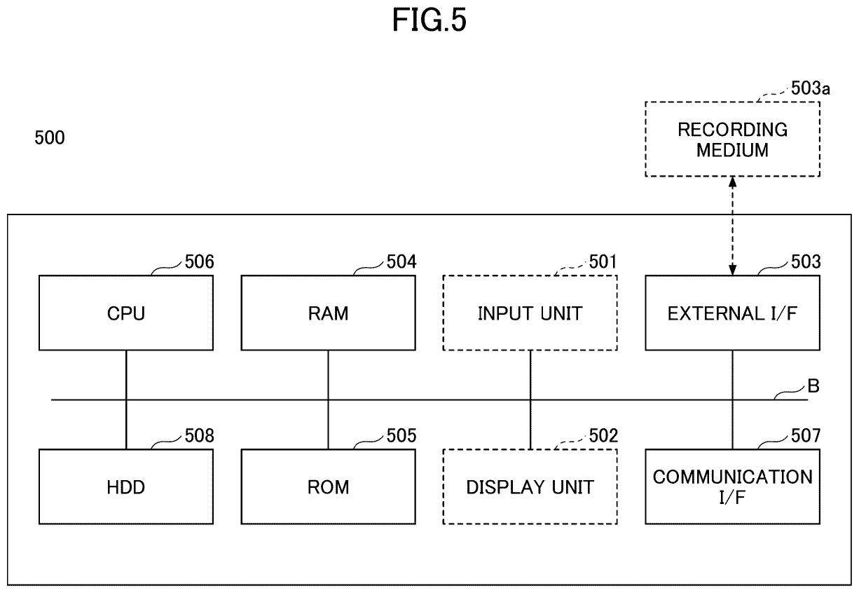

The large language model running apparatus 410, the automated question answering apparatus 420, and the client 440 may be realized by a computer having a hardware structure shown in FIG. 5, for example. FIG. 5 illustrates an exemplary hardware structure of a computer 500 in accordance with an embodiment of the present disclosure.

As represented in FIG. 5, the computer 500 includes an input unit 501, a display unit 502, an external I/F (Interface) 503, a RAM (Random Access Memory) 504, a ROM (Read Only Memory) 505, a CPU (Central Processing Unit) 506, a communication I/F 507, a HDD (Hard Disk Drive) 508, and the like, that are connected to each other via a bus B. Optionally, the input unit 501 and the display unit 502 may be connected when necessary, and the computer may further include a recording medium 503a as needed.

Here, it should be noted that the above components included in the computer 500 may be implemented by making use of existing technologies that are well-known to a person in the art. As such, the related details are omitted for the sake of convenience.

### (2) Mobile Terminal

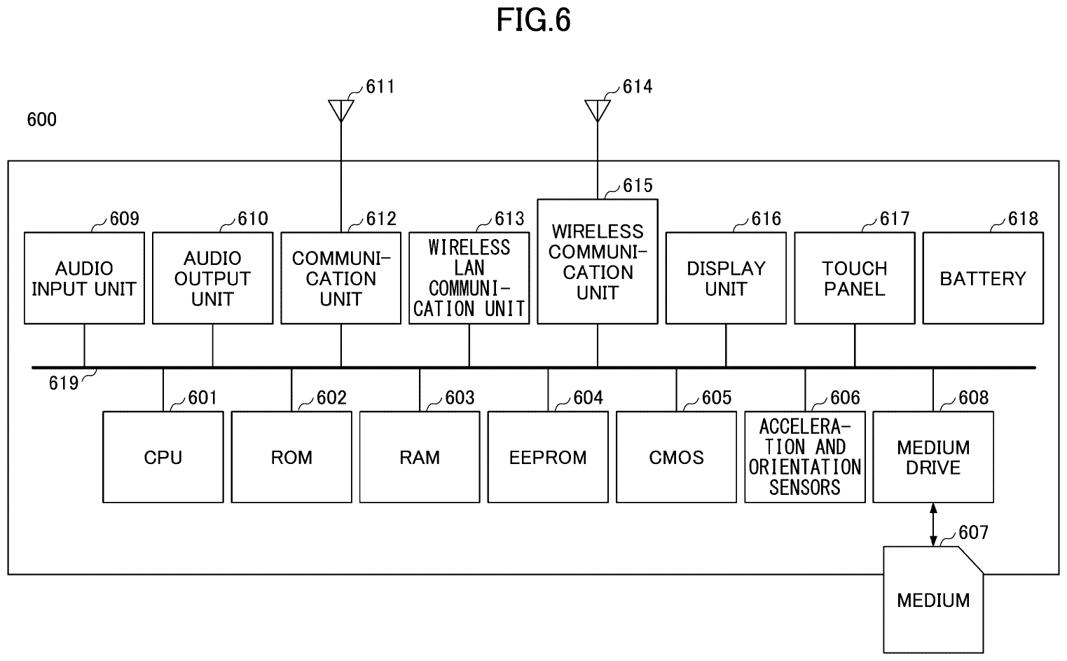

For example, the client 440 may be materialized by a mobile terminal having a hardware structure shown in FIG. 6. In FIG. 6, an exemplary hardware structure of a mobile terminal 600 in accordance with an embodiment of the present disclosure is illustrated.

As shown in FIG. 6, the mobile terminal 600 contains a CPU 601, a ROM 602, a RAM 603, an EEPROM (Electrically Erasable Programmable Read Only Memory) 604, a CMOS (Complementary Metal Oxide Semiconductor) 605, acceleration and orientation sensors 606, a medium 607 (e.g., a recording medium), a medium drive 608, an audio input unit 609, an audio output unit 610, an antenna 611, a communication unit 612, a wireless LAN (Local Area Network) communication unit 613, an antenna 614, a wireless communication unit 615, a display unit 616, a touch panel 617, a battery 618, a bus 619, and so on. The bus 619 includes an address bus, a data bus, etc., so as to electrically connect these components.

Here, it should be noted that the above components contained in the mobile terminal 600 may be implemented by taking advantage of conventional technologies that are well-known to a person in the art. As such, for the sake of convenience, the related details are omitted.

### Software Structure

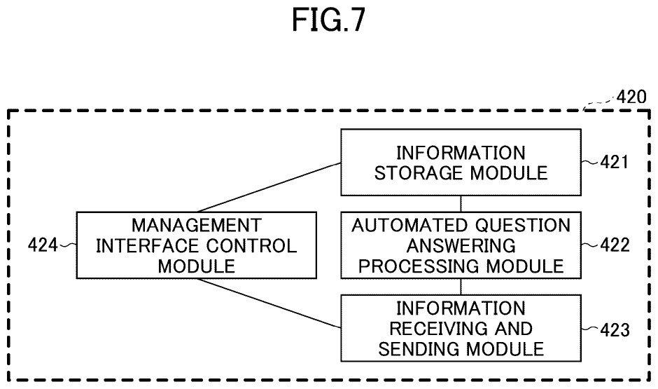

The automated question answering apparatus 420 may be implemented by, for example, functional modules shown in FIG. 7. FIG. 7 is an exemplary diagram of the functional modules for achieving the automated question answering apparatus 420, in accordance with an embodiment of the present disclosure. As represented in FIG. 7, the automated question answering apparatus 420 includes an information storage module 421, an automated question answering processing module 422, an information receiving and sending module 423, and a management interface control module 424.

The information storage module 421 stores the configuration information input by an administrator using a management interface. Moreover, the information storage module 421 may further store information such as the question input by the client 440, the answer obtained by the automated question answering processing module 422, and so forth.

The automated question answering processing module 422 obtains, by interacting with the large language model 401 and the question answering system 430, the answer to the question, and sends the answer to the information receiving and sending module 423.

The information receiving and sending module 423 receives the question from the client 440, forwards the question to the automated question answering processing module 422, receives the answer returned by the automated question answering processing module 422, and sends the answer to the client 440.

The management interface control module 424 receives the configuration information input by the administrator using the management interface, and configures the automated question answering apparatus 420 on the basis of the configuration information. Specifically, the configuration information includes but is not limited to a question answering system name and address, the address of the large language model 401, the number of candidate options, the candidate option numbers, the candidate option contents, a prompt template, an answer template, etc.

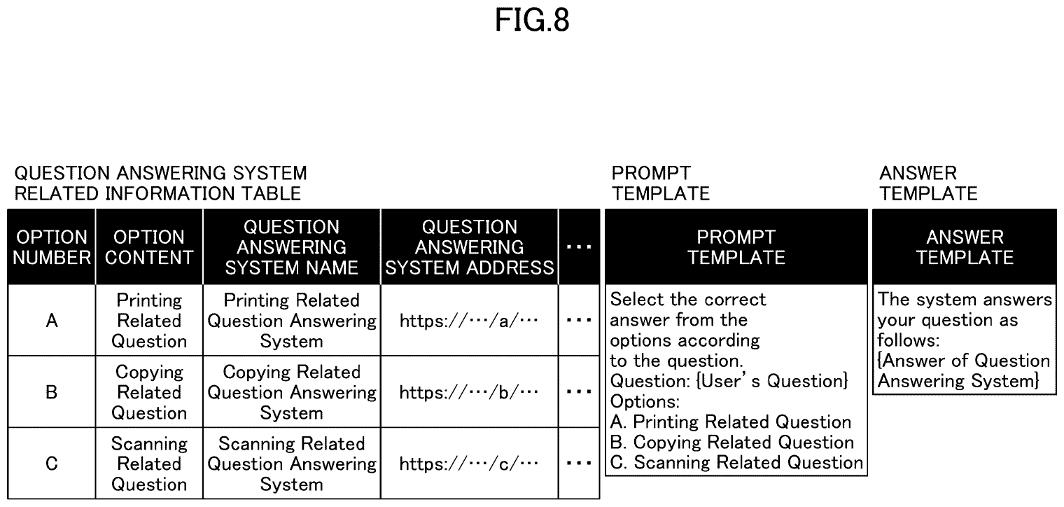

FIG. 8 provides an example of a question answering system related information table, that may be a table stored in the information storage module 421. The question answering system related information table contains information such as the candidate option numbers (e.g., A, B, C, etc.), the candidate option contents (e.g., a printing related question, a copying related question, a scanning related question, etc.), the question answering system name (e.g., a printing related question answering system, a copying related question answering system, a scanning related question answering system, etc.), the question answering system address, and so on. The question answering system related information table may be set by the administrator using the management interface control module 424. Furthermore, FIG. 8 also provides examples of a prompt template and an answer template, that may also be stored in the information storage module 421.

For example, the prompt template is shown in the following Table 8.

```
TABLE 8
Select the correct answer from the options according to the question.
Question: {User's Question}
Options:
  A. Printing Related Question
  B. Copying Related Question
  C. Scanning Related Question
```

In the prompt template represented in Table 8, User's Question is the question input by the client 440, and the number of candidate options, the candidate option numbers, the candidate option contents, etc. may be set or modified by the administrator using the management interface control module 424.

The answer template is illustrated in the following Table 9, for example.

TABLE 9

The system answers your question as follows:
{Answer of Question Answering System}

In the answer template shown in Table 9, Answer of Question Answering System is the answer to the question obtained by the automated question answering system 400; here, it may specifically be a certain candidate option number, for example, A.

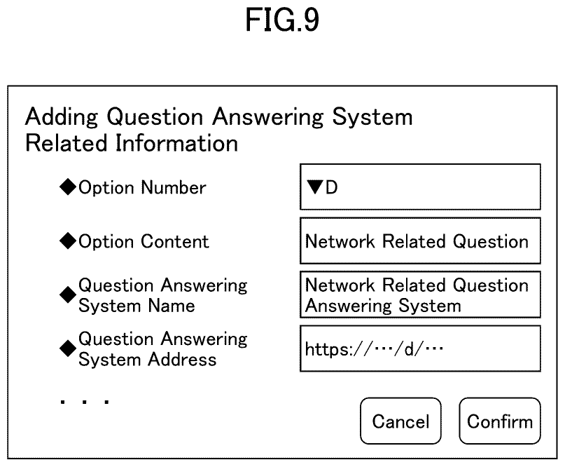

It is worth noting that in the prompt template shown in FIG. 8, although three candidate options (numbered A, B, and C, respectively) are included, in actual applications, the candidate options may be added, deleted, or modified as needed. FIG. 9 provides an example of adding a candidate option. Concretely, the automated question answering apparatus 420 may control, by the management interface control module 424, the display unit 502 to display the interface shown in FIG. 9 for adding question answering system related information. The administrator may input the configuration information of the relevant item through the interface, for example, the configuration information of the adding operation. In the example of FIG. 9, a candidate option is added; its number is D, and its content is Network Related Question. Moreover, it is also possible to set information such as a question answering system name and address, and the like. Of course, the management interface control module 424 may also send the data of the interface to the client 440 connected to the automated question answering apparatus 420 via the relating network, so that the client 440 may display the interface on the client's display unit through an application such as a browser, and so on. In this way, the user having the authority to configure the automated question answering apparatus 420 may input the relevant configuration information on the interface by means of the client 440. After the relevant configuration information is input, by clicking the confirmation button on the interface, it is possible to submit the relevant configuration information to the information storage module 421.

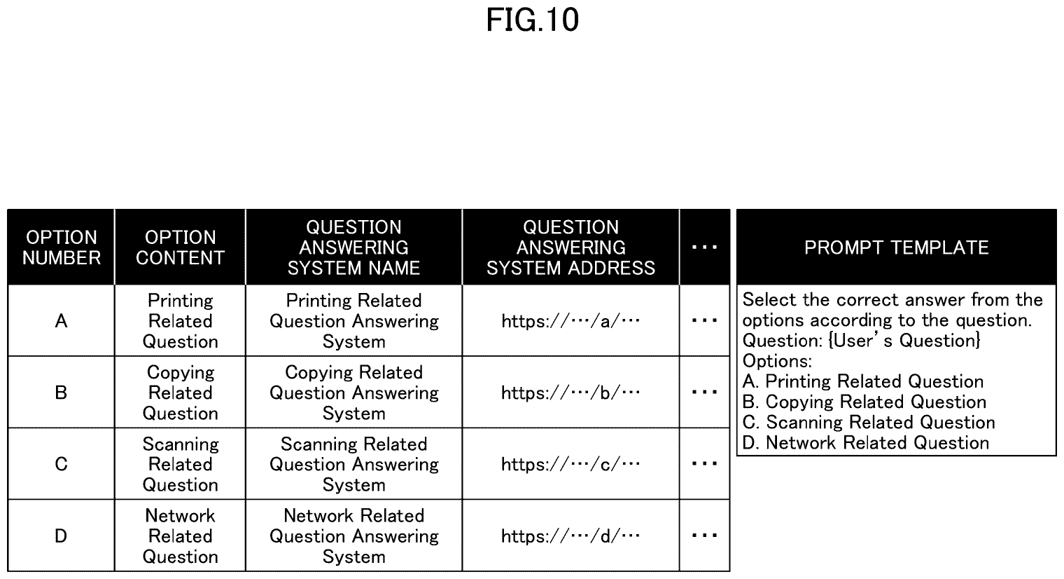

The management interface control module 424 registers the data of each item set through the interface in the question answering system related information table stored in the information storage module 421, and updates the prompt template stored in the information storage module 421 at the same time. FIG. 10 shows the updated question answering system related information table and the updated prompt template stored in the information storage module 421 after adding the option D. As represented in FIG. 10, the last line of the updated question answering system related information table is the newly added information, and D. Network Related Question in the updated prompt template is the newly added information.

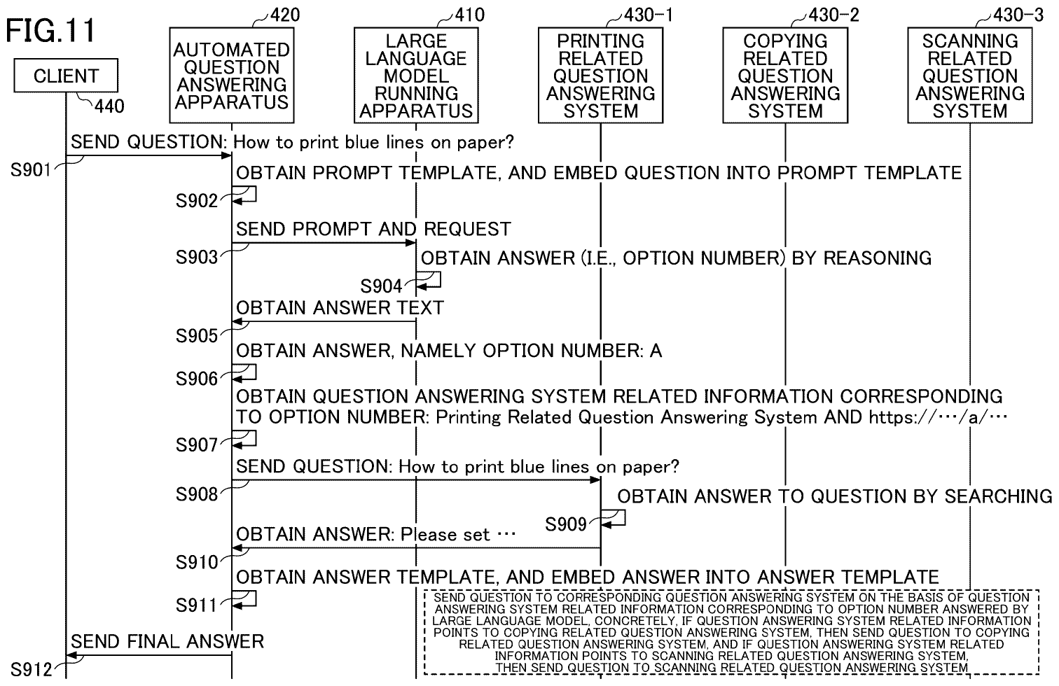

Hereinafter, in conjunction with FIG. 11, an example of a workflow of the automated question answering system 400 is provided. In the workflow, a large language model (e.g., the large language model 401) trained by the above embodiments is utilized for carrying out reasoning, so as to provide an answer (also called an answer text) to a question (also called a question text) raised by a user. The workflow specifically includes STEPS S901 to S912.

In STEP S901, the user sends a question (also called a question text), for example, “How to print blue lines on paper?” to the automated question answering apparatus 420 through the client 440; the automated question answering apparatus 420 receives the question sent by the client 440. Concretely, the information receiving and sending module 423 receives the question sent by the client 440.

In STEP S902, the automated question answering apparatus 420 obtains a prompt template, and embeds the question into the prompt template to generate a prompt. Specifically, the automated question answering processing module 422 obtains the prompt template from the information storage module 421, and embeds the question into the prompt template to generate the prompt.

In STEP S903, the automated question answering apparatus 420 sends the prompt and a request (also called an answer request) to the large language model running apparatus 410 to request the answer to the question. Specifically, the information receiving and sending module 423 sends the prompt and the request to the large language model running apparatus 410.

In STEP S904, the large language model running apparatus 410 obtains the answer by means of the reasoning of the large language model 401. The answer may be the option number of a certain option.

In STEP S905, the large language model running apparatus 410 sends the answer (e.g., an option number A) to the automated question answering apparatus 420; the automated question-answering apparatus 420 receives the answer. Concretely, the information receiving and sending module 423 receives the answer from the large language model running apparatus 410.

In STEP S906, the automated question answering apparatus 420 obtains the answer, namely the option number A. Specifically, the automated question answering processing module 422 obtains the option number A by parsing the answer.

In STEP S907, the automated question answering apparatus 420 obtains the question answering system related information corresponding to the option number A, for example, a printing related question answering system and https:// . . . /a/ . . . . Concretely, the automated question answering processing module 422 looks up the question answering system related information table stored in the information storage module 423 to obtain the question answering system related information corresponding to the option number A.

In STEP S908, the automated question answering apparatus 420 sends the question to the corresponding question answering system on the basis of the question answering system related information corresponding to the option number A; for instance, in this example, the question is sent to the printing related question answering system 430-1. Specifically, the automated question answering processing module 422 instructs the information receiving and sending module 423 to send the question to the printing related question answering system 430-1 on the basis of the question answering system address in the obtained question answering system related information.

In STEP S909, the printing related question answering system 430-1 searches its database on the basis of the received question to obtain the answer. For example, the answer may be “Please set . . . ”, thereby providing the client 440 with the answer to the question.

In STEP S910, the printing related question answering system 430-1 sends the answer to the automated question answering apparatus 420; the automated question answering apparatus 420 receives the answer. Specifically, the information receiving and sending module 423 receives the answer.

In STEP S911, the automated question answering apparatus 420 obtains an answer template, and embeds the answer into the answer template, so as to generate a final answer. Concretely, the automated question answering processing module 422 obtains the answer template from the information storage module 421, and embeds the answer into the answer template to generate the final answer.

In STEP S912, the automated question answering apparatus 420 sends the final answer to the client 440. The client 440 displays the final answer by means of its display unit (e.g. the display unit 616 shown in FIG. 6), thereby obtaining the answer to the question. Specifically, the information receiving and sending module 423 sends the final answer to the client 440, so that the final answer is displayed on the interface of the display unit of the client 440.

In this way, the user can make appropriate processing on the basis of the answer to the question, thereby solving the problem he/she encounters.

In the workflow above, for each question answering system, it is possible to send the question to the corresponding question answering system on the basis of the question answering system related information corresponding to the option number answered by the large language model 401. Concretely, if the question answering system related information points to the copying related question answering system, then the question is sent to the copying related question answering system; if the question answering system related information points to the scanning related question answering system, then the question is sent to the scanning related question answering system; and so on.

Additionally, it is worth noting that the automated question answering system 400 is only an application example; that is, the embodiments of the present disclosure are not limited to this application example. For instance, it is also possible to use the large language model 401 to obtain, based on the question raised by the user, the category (or class) of the user's question (e.g., travel, medical care, weather, or education), and then, ask a large language model, that is good at the category and has been associated in advance, to obtain the answer. Furthermore, it is not only possible to ask the large language model good at the category but also possible to ask a customer service good at the category to obtain the answer.

Here, it should be pointed out that the above embodiments of the present disclosure are just exemplary ones, and the specific structure and operation of them are not be used for limiting the embodiments of the present disclosure.

In addition, the embodiments of the present disclosure may be implemented in any convenient form, for example, using dedicated hardware or a mixture of dedicated hardware and software. The embodiments of the present disclosure may be implemented as computer software executed by one or more networked processing apparatuses. The network may include any conventional terrestrial or wireless communications network, such as the Internet, and the like. The processing apparatuses may include any suitably programmed apparatuses such as a general-purpose computer, a personal digital assistant, a mobile telephone (such as a WAP or 3G, 4G, or 5G-compliant phone), and so on. Because the embodiments of the present disclosure may be implemented as software, each and every aspect of the present disclosure thus encompasses computer software implementable on a programmable device.

The computer software may be provided to the programmable device using any storage medium for storing processor-readable code such as a floppy disk, a hard disk, a CD ROM, a magnetic tape device, a solid state memory device, and so forth.

The related hardware platform may include any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of storing a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

While the present disclosure is described with reference to the specific embodiments chosen for purpose of illustration, it should be apparent that the present disclosure is not limited to these embodiments, but numerous modifications may be made thereto by a person skilled in the art without departing from the basic concept and technical scope of the present disclosure.

What is claimed is:

1. A method of fine-tuning a large language model, comprising:
obtaining training data containing first training data and second training data, wherein, the first training data includes a question, a plurality of candidate option numbers and their corresponding candidate option contents, and a correct option number and its corresponding correct option content, the correct option number and its corresponding correct option content are one of the plurality of the candidate option numbers and their corresponding candidate option contents, respectively, and the second training data is obtained by masking a candidate option content in the first training data;
inputting the training data into the large language model to generate a predicted result by utilizing the large language model; and
optimizing the large language model based on the predicted result as well as the correct option number and its corresponding correct option content.

2. The method according to claim 1, wherein,
the optimizing the large language model based on the predicted result as well as the correct option number and its corresponding correct option content includes:
calculating a first loss between a predicted option number in the predicted result and the correct option number;
calculating, for the second training data in which the predicted option number is identical to the correct option number and the masked candidate option content is identical to the correct option content, a second loss between a predicted option content in the predicted result and the correct option content; and
calculating a total loss based on the first loss and the second loss to optimize the large language model with a goal of minimizing the total loss.

3. The method according to claim 2, wherein,
the inputting the training data into the large language model to generate the predicted result by utilizing the large language model includes:
converting, by way of a tokenizer, each token in the training data into a corresponding ID to acquire a first ID list composed of the corresponding ID of each token, and replacing each first-class ID in the first ID list with a predetermined ID to acquire a second ID list corresponding to the first ID list, wherein, the first-class IDs are remaining IDs except IDs corresponding to the correct option number and the correct option content, and tokens corresponding to the predetermined ID are ignored in a process of optimizing the large language model; and
inputting the first ID list into the large language model to generate the predicted result by utilizing the large language model, wherein, an i-th predicted value in the predicted result is a predicted result for an i+1-th ID in the first ID list, generated by the large language model based on a part of IDs in the first ID list up to the i-th ID.

4. The method according to claim 3, wherein,
the first loss between the predicted option number and the correct option number is represented by a loss value between an ID corresponding to the predicted option number and an ID corresponding to the correct option number, and the second loss between the predicted option content and the correct option content is represented by a loss value between an ID corresponding to the predicted option content and an ID corresponding to the correct option content.

5. The method according to claim 4, further comprising:
determining a second position based on a first position of the ID corresponding to the correct option number, in the second ID list, wherein, the second position is a previous position of the first position, obtaining a predicted value at the second position from the predicted result to acquire a probability value of each ID in the tokenizer, and selecting an ID with a maximum probability value to serve as the ID corresponding to the predicted option number; and
determining a fourth position based on a third position of the ID corresponding to the correct option content, in the second ID list, wherein, the fourth position contains a previous sub-position of each sub-position in the third position, obtaining a predicted value at the fourth position from the predicted result to acquire a probability value of each ID in the tokenizer, and selecting an ID with a maximum probability value to serve as the ID corresponding to the predicted option content.

6. The method according to claim 1, wherein,
the obtaining the training data containing the first training data and the second training data includes:
acquiring original training data with a label, wherein, the original training data contains at least a question, a plurality of candidate option contents, and the label, and the label is used to indicate a correct option content in the plurality of candidate option contents;
constructing a prompt based on a prompt template and the original training data, and stitching contents in the prompt to acquire the first training data corresponding to the original training data; and
replacing any one of the plurality of candidate option contents in the first training data with a mask to acquire the second training data corresponding to the original training data.

7. The method according to claim 1, further comprising:
receiving a text to be inferred, wherein, the text to be inferred contains a first question as well as a plurality f candidate option numbers and their corresponding option contents;
inputting the text to be inferred into the optimized large language model, and setting the optimized large language model to generate only a predicted result of a correct option number; and
determining a correct option number and/or a correct option content based on the predicted result of the correct option number, generated by the optimized large language model.

8. The method according to claim 7, wherein,
the first question in the text to be inferred is received from a client, and the plurality of candidate option numbers in the text to be inferred are set based on setting information or setting update information received by a user interface.

9. An apparatus for fine-tuning a large language model, comprising:
a processor; and
a storage storing a computer program, coupled to the processor,
wherein, the computer program causes, when executed by the processor, the processor to implement
obtaining training data containing first training data and second training data, wherein, the first training data includes a question, a plurality of candidate option numbers and their corresponding candidate option contents, and a correct option number and its corresponding correct option content, the correct option number and its corresponding correct option content are one of the plurality of the candidate option numbers and their corresponding candidate option contents, respectively, and the second training data is obtained by masking a candidate option content in the first training data;
inputting the training data into the large language model to generate a predicted result by utilizing the large language model; and
optimizing the large language model based on the predicted result as well as the correct option number and its corresponding correct option content.

10. The apparatus according to claim 9, wherein,
the optimizing the large language model based on the predicted result as well as the correct option number and its corresponding correct option content includes:
calculating a first loss between a predicted option number in the predicted result and the correct option number;
calculating, for the second training data in which the predicted option number is identical to the correct option number and the masked candidate option content is identical to the correct option content, a second loss between a predicted option content in the predicted result and the correct option content; and
calculating a total loss based on the first loss and the second loss to optimize the large language model with a goal of minimizing the total loss.

11. The apparatus according to claim 10, wherein,
the inputting the training data into the large language model to generate the predicted result by utilizing the large language model includes:
converting, by way of a tokenizer, each token in the training data into a corresponding ID to acquire a first ID list composed of the corresponding ID of each token, and replacing each first-class ID in the first ID list with a predetermined ID to acquire a second ID list corresponding to the first ID list, wherein, the first-class IDs are remaining IDs except IDs corresponding to the correct option number and the correct option content, and tokens corresponding to the predetermined ID are ignored in a process of optimizing the large language model; and
inputting the first ID list into the large language model to generate the predicted result by utilizing the large language model, wherein, an i-th predicted value in the predicted result is a predicted result for an i+1-th ID in the first ID list, generated by the large language model based on a part of IDs in the first ID list up to the i-th ID.

12. The apparatus according to claim 11, wherein,
the first loss between the predicted option number and the correct option number is represented by a loss value between an ID corresponding to the predicted option number and an ID corresponding to the correct option number, and the second loss between the predicted option content and the correct option content is represented by a loss value between an ID corresponding to the predicted option content and an ID corresponding to the correct option content.

13. The apparatus according to claim 12, wherein, the computer program causes, when executed by the processor, the processor to further implement:
determining a second position based on a first position of the ID corresponding to the correct option number, in the second ID list, wherein, the second position is a previous position of the first position, obtaining a predicted value at the second position from the predicted result to acquire a probability value of each ID in the tokenizer, and selecting an ID with a maximum probability value to serve as the ID corresponding to the predicted option number; and
determining a fourth position based on a third position of the ID corresponding to the correct option content, in the second ID list, wherein, the fourth position contains a previous sub-position of each sub-position in the third position, obtaining a predicted value at the fourth position from the predicted result to acquire a probability value of each ID in the tokenizer, and selecting an ID with a maximum probability value to serve as the ID corresponding to the predicted option content.

14. The apparatus according to claim 9, wherein,
the obtaining the training data containing the first training data and the second training data includes:
acquiring original training data with a label, wherein, the original training data contains at least a question, a plurality of candidate option contents, and the label, and the label is used to indicate a correct option content in the plurality of candidate option contents;
constructing a prompt based on a prompt template and the original training data, and stitching contents in the prompt to acquire the first training data corresponding to the original training data; and
replacing any one of the plurality of candidate option contents in the first training data with a mask to acquire the second training data corresponding to the original training data.

15. The apparatus according to claim 9, wherein, the computer program causes, when executed by the processor, the processor to further implement:
receiving a text to be inferred, wherein, the text to be inferred contains a first question as well as a plurality of candidate option numbers and their corresponding option contents;
inputting the text to be inferred into the optimized large language model, and setting the optimized large language model to generate only a predicted result of a correct option number; and
determining a correct option number and/or a correct option content based on the predicted result of the correct option number, generated by the optimized large language model.

16. The apparatus according to claim 15, wherein,
the first question in the text to be inferred is received from a client, and the plurality of candidate option numbers in the text to be inferred are set based on setting information or setting update information received by a user interface.

17. A non-transitory computer-readable medium storing a computer program for execution by a processor, wherein,
the computer program causes, when executed by the processor, the processor to implement:
obtaining training data containing first training data and second training data, wherein, the first training data includes a question, a plurality of candidate option numbers and their corresponding candidate option contents, and a correct option number and its corresponding correct option content, the correct option number and its corresponding correct option content are one of the plurality of the candidate option numbers and their corresponding candidate option contents, respectively, and the second training data is obtained by masking a candidate option content in the first training data;
inputting the training data into the large language model to generate a predicted result by utilizing the large language model; and
optimizing the large language model based on the predicted result as well as the correct option number and its corresponding correct option content.

18. The non-transitory computer-readable medium according to claim 17, wherein,
the optimizing the large language model based on the predicted result as well as the correct option number and its corresponding correct option content includes:
calculating a first loss between a predicted option number in the predicted result and the correct option number;
calculating, for the second training data in which the predicted option number is identical to the correct option number and the masked candidate option content is identical to the correct option content, a second loss between a predicted option content in the predicted result and the correct option content; and
calculating a total loss based on the first loss and the second loss to optimize the large language model with a goal of minimizing the total loss.

19. The non-transitory computer-readable medium according to claim 18, wherein,
the inputting the training data into the large language model to generate the predicted result by utilizing the large language model includes:
converting, by way of a tokenizer, each token in the training data into a corresponding ID to acquire a first ID list composed of the corresponding ID of each token, and replacing each first-class ID in the first ID list with a predetermined ID to acquire a second ID list corresponding to the first ID list, wherein, the first-class IDs are remaining IDs except IDs corresponding to the correct option number and the correct option content, and tokens corresponding to the predetermined ID are ignored in a process of optimizing the large language model; and
inputting the first ID list into the large language model to generate the predicted result by utilizing the large language model, wherein, an i-th predicted value in the predicted result is a predicted result for an i+1-th ID in the first ID list, generated by the large language model based on a part of IDs in the first ID list up to the i-th ID.
